(19) United States
(12) Patent Application Publication
(10) Pub. No.: US 2025/0058631 A1
(43) Pub. Date: Feb. 20, 2025

(54) METHOD OF GUIDING SHIFTABLE GEAR STAGE OF A VEHICLE

(71) Applicants: HYUNDAI MOTOR COMPANY, Seoul (KR); KIA CORPORATION, Seoul (KR)

(72) Inventors: Sung Hyun Cho, Yongin-si (KR); Soo Han Song, Seoul (KR); Seong Hwan Cheong, Suwon-si (KR); Joseph D. Chang, Suwon-si (KR)

(73) Assignees: HYUNDAI MOTOR COMPANY, Seoul (KR); KIA CORPORATION, Seoul (KR)

(21) Appl. No.: 18/772,897

(22) Filed: Jul. 15, 2024

(30) Foreign Application Priority Data
Aug. 14, 2023 (KR) 10-2023-0106061
Dec. 11, 2023 (KR) 10-2023-0178727

(51) Int. Cl. B60K 35/28; B60L 3/12

(52) U.S. Cl. CPC B60K 35/28; B60L 3/12; B60K 2360/167; B60L 2240/12; B60L 2240/486; B60L 2250/16; B60L 2250/28

(57) ABSTRACT

A method of guiding a shiftable gear stage of a vehicle provides information about a shiftable gear stage by a driver in a manual shift mode of a virtual gear shift system of the vehicle. The method includes: determining, by a control unit, whether a virtual gear shift system of an electric vehicle enters a manual shift mode; when the virtual gear shift system enters the manual shift mode; determining a shiftable gear stage by a driver on the basis of a current vehicle speed; and outputting and displaying the determined shiftable gear stage on a display device inside the electric vehicle.

### CROSS-REFERENCE TO RELATED APPLICATION

This application claims under 35 U.S.C. § 119 (a) the benefit of and priority to Korean Patent Application No. 10-2023-0178727, filed on Dec. 11, 2023, and Korean Provisional Application No. 10-2023-0106061, filed on Aug. 14, 2023, the entire contents of which are incorporated herein by reference.

### BACKGROUND

### (a) Technical Field

The present disclosure relates to a method of guiding a shiftable gear stage of a vehicle, and more specifically, to a method of guiding a shiftable gear stage of a vehicle in a manual shift mode of a virtual gear shift system.

### (b) Background Art

In general, an internal combustion engine vehicle is equipped with an engine and a transmission, and displays information about an engine speed and a gear shift range on a dashboard so that a driver can recognize a real-time driving status.

An electric vehicle may be equipped with a motor and a virtual gear shift system, instead of an engine, and displays a virtual engine speed and a virtual gear stage on a dashboard using the virtual gear shift system, thereby providing a driver with a feeling similar to that experienced in an internal combustion engine vehicle.

In addition, the virtual gear shift system may display the virtual engine speed on the dashboard and generate virtual engine sounds, thereby providing the driver with auditory effects similar to those experienced when riding in an internal combustion engine vehicle.

A conventional virtual gear shift system displays a virtual engine speed and a virtual gear stage on a dashboard when entering a manual shift mode, thereby allowing a driver to determine a driving force according to a current virtual engine speed and manually manipulate the shift gear stage.

Here, the driver may perform upshift or downshift on the basis of the information (i.e., the virtual engine speed and the virtual gear stage) provided through the dashboard.

However, because it is difficult for the driver to accurately determine a shiftable gear stage in real time using only the information provided through the dashboard, the driver performs manual shifting based not only on the information provided through the dashboard but also on the driver's experiences.

Here, the driver determines whether to perform shifting on the basis of the driver's experiences and knowledge on a gear ratio determined for each gear stage, and also determines a shift gear stage. Accordingly, in a case where the driver can make an empirical determination according to the experience and knowledge, the driver performs manual shifting. However, when the driver cannot make the empirical determination according to the experience and knowledge, it is difficult to determine whether the shifting is actually possible or impossible, thus the driver has to perform upshifting and downshifting.

As described above, in the conventional virtual gear shift system, when in the manual shift mode, the limited information provided to the driver necessitates reliance on the driver's experience or the like, thereby reducing driving convenience.

The above information disclosed in this Background section is provided only to enhance understanding of the background of the present disclosure and therefore it may contain information that does not form the prior art that is already known to a person of ordinary skill in the art.

### SUMMARY

The present disclosure has been made in an effort to solve the above-described problems associated with prior art. An object of the present disclosure is to provide a method of guiding a shiftable gear stage for a vehicle, capable of enhancing driving convenience in a manual shift mode by providing information on a shiftable gear stage in real time so that a driver can recognize the information.

The object of the present disclosure is not limited thereto, and other objects of the present disclosure not mentioned above should be clearly understood by those having ordinary skill in the art from the following description.

In one aspect of the present disclosure, a method of guiding a shiftable gear stage of an electric vehicle includes: determining, by a control unit, whether a virtual gear shift system of an electric vehicle enters a manual shift mode; in response to determining that the virtual gear shift system enters the manual shift mode, determining, by the control unit, a shiftable gear stage based on a current vehicle speed; and outputting and displaying the determined shiftable gear stage on a display device inside the electric vehicle.

In another embodiment, determining the shiftable gear stage may include: determining a downshiftable gear stage lower than the current virtual gear stage based on the current vehicle speed; and determining an upshiftable gear stage higher than the current virtual gear stage based on the current vehicle speed.

In an embodiment, determining the downshiftable gear stage may include: comparing the current shiftable gear stage with a first gear stage and comparing the current vehicle speed with a determined downshift vehicle speed. In particular, when the current shiftable gear stage is higher than the first gear stage and the current vehicle speed is less than the downshift vehicle speed, the current shiftable gear stage is compared with a second gear stage. The method further includes: when the current shiftable gear stage is higher than the second gear stage, determining a gear stage one level lower than the current shiftable gear stage as the downshiftable gear stage.

In still another embodiment, determining the downshiftable gear stage may be repeatedly performed until the current shiftable gear stage becomes the first gear stage or lower, or the current vehicle speed becomes the downshift vehicle speed or higher.

In yet another embodiment, comparing the current shiftable gear stage with the second gear stage may include: determining the downshiftable gear stage as the first gear stage when the current shiftable gear stage is the second gear stage or lower.

In still yet another embodiment, the downshift vehicle speed may be determined based on a current opening degree of an accelerator pedal and a gear ratio determined based on a gear stage one level lower than the current virtual gear stage.

In a further embodiment, when the virtual gear shift system enters the manual shift mode, the current shiftable gear stage may be determined to be the same as the current virtual gear stage.

In another further embodiment, the current virtual gear stage may be determined on the basis of the current vehicle speed when the virtual gear shift system enters the manual shift mode.

In still another further embodiment, determining the upshiftable gear stage may include: comparing the current vehicle speed with a predetermined upshift vehicle speed; comparing, when the current vehicle speed is higher than the upshift vehicle speed, the current shiftable gear stage with a determined highest gear stage; and determining, when the current shiftable gear stage is less than the highest gear stage, a gear stage one level higher than the current shiftable gear stage as the upshiftable gear stage.

Further, determining the upshiftable gear stage may be repeatedly performed until the current shiftable gear stage becomes the highest gear stage or higher, or the current vehicle speed becomes the upshiftable vehicle speed or lower.

In addition, comparing the current shiftable gear with the highest gear stage may include: determining, when the current shiftable gear stage is the highest gear stage or higher, the upshiftable gear stage as the highest gear stage.

Furthermore, the upshift vehicle speed may be determined based on a current opening degree of an accelerator pedal and a gear ratio determined based on a gear stage one level higher than the current virtual gear stage.

Other aspects and embodiments of the present disclosure are discussed below.

It is to be understood that the term “vehicle” or other similar terms as used herein are inclusive of motor vehicles in general such as passenger automobiles including sport utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example, vehicles powered by both electricity and gasoline.

The above and other features of the present disclosure are discussed below.

### BRIEF DESCRIPTION OF THE DRAWINGS

The above and other features of the present disclosure are now described in detail with reference to certain embodiments thereof illustrated the accompanying drawings which are given hereinafter by way of illustration only, and thus are not limitative of the present disclosure, and wherein:

FIG. 1 is a diagram showing a main configuration of a system for guiding a shiftable gear stage of a vehicle according to an embodiment of the present disclosure;

FIG. 2 is a diagram showing a dashboard provided with an AGI (Available Gear Indicator) according to an embodiment of the present disclosure; and

FIGS. 3 and 4 are flowcharts showing a method of guiding a shiftable gear stage of a vehicle according to an embodiment of the present disclosure.

It should be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes should be determined in part by the particular intended application and use environment.

In the figures, reference numbers refer to the same or equivalent parts of the present disclosure throughout the several figures of the drawing.

### DETAILED DESCRIPTION

Hereinafter, reference is made in detail to various embodiments of the present disclosure, examples of which are illustrated in the accompanying drawings and described below. While the present disclosure is described in conjunction with certain embodiments, it should be understood that the present description is not intended to limit the present disclosure to the embodiments. On the contrary, the present disclosure is intended to cover not only the embodiments, but also various alternatives, modifications, equivalents and other embodiments, within the spirit and scope of the present disclosure as defined by the appended claims.

The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

When a component, device, element, or the like of the present disclosure is described as having a purpose or performing an operation, function, or the like, the component, device, or element should be considered herein as being “configured to” meet that purpose or to perform that operation or function.

The present disclosure provides information on a shiftable gear stage in real time to a driver of an electric vehicle equipped with a virtual gear shift system (VGS). According to the present disclosure, it is possible to increase driving convenience in a manual shift mode of the VGS by providing information on a gear shiftable range in real time so that a driver can recognize the information.

A virtual gear shift system of an electric vehicle is designed to provide a driver with a feeling similar to that experienced when riding in an internal combustion engine vehicle. The virtual gear shift system may provide the driver with a visual feeling similar to that experienced when riding in an internal combustion engine vehicle by displaying a virtual engine speed and a virtual gear stage on a dashboard.

Further, the virtual gear shift system includes: a gear shift device that the driver can manually operate when entering the manual shift mode. The driver may change the virtual gear stage displayed on the dashboard by operating the gear shift device. The gear shift device may be provided to facilitate a driver's operation inside the vehicle, and may be provided on a steering wheel, for example. The gear shift device provided on the steering wheel is also called a paddle shifter or a shift control device.

The virtual gear shift system may determine the virtual gear stage on the basis of a vehicle speed and an opening degree (%) of an accelerator pedal in an automatic shift mode. In a manual shift mode, the virtual gear shift system may determine a current virtual gear stage based on: i) a virtual gear stage when entering the manual shift mode and ii) a driver's shift request signal input through the gear shift device.

The virtual gear shift system may be selectively activated by the driver. For example, a touch button for activating the virtual gear shift system may be provided on a vehicle's navigation screen, and the virtual gear shift system may be activated as the driver touches the touch button.

Additionally, the virtual gear shift system may selectively enter the manual shift mode by the driver. For example, in the automatic shift mode, the driver operates the gear shift device of the virtual gear shift system to switch to the manual shift mode, then the virtual gear shift system enters the manual shift mode.

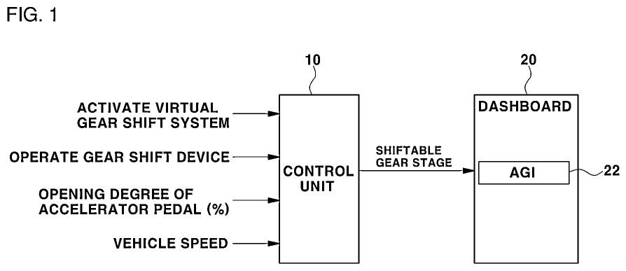

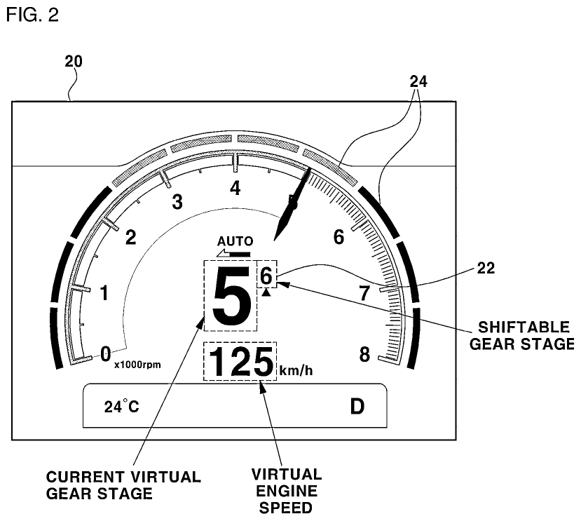

FIG. 1 is a diagram showing a main configuration of a system for guiding a shiftable gear stage of a vehicle according to an embodiment of the present disclosure, and FIG. 2 is a diagram showing a dashboard provided with an AGI (Available Gear Indicator) according to an embodiment of the present disclosure. The AGI is also called a shiftable gear indicator.

Referring to FIG. 1, when a virtual gear shift system is activated, a control unit 10 according to an embodiment of the present disclosure determines a current virtual gear stage (i.e., real-time virtual gear stage) on the basis of a vehicle speed and an opening degree of an accelerator pedal. The control unit 10 may be configured to perform overall control of the virtual gear shift system. The control unit 10 may receive a signal for determining whether the virtual gear shift system is activated from a vehicle's AVN (Audio, Video, Navigation) system.

The virtual gear shift system in an automatic shift mode may enter a manual shift mode when a driver's intention to perform manual shifting is detected. For example, when the driver operates the gear shift device in the automatic shift mode to enter the manual shift mode, a signal generated by operating the gear shift device is input to the control unit 10, and the control unit 10 causes the virtual gear shift system to enter the manual shift mode.

In addition, in a case where the virtual gear shift system is activated, the control unit 10 calculates a virtual engine speed according to a real-time virtual gear stage, and outputs and displays the calculated virtual engine speed on a dashboard 20.

Further, when the virtual gear shift system enters the manual shift mode, the control unit 10 displays information on a virtual gear stage that is manually shiftable by a driver on the basis of a current virtual gear stage and a current vehicle speed (i.e., real-time vehicle speed) on the dashboard 20 so that the driver can recognize the result.

The dashboard 20 is configured to display a variety of information about driving states of the vehicle, and includes an AGI (Available Gear Indicator) 22 for outputting and displaying a shiftable gear stage, as shown in FIG. 2.

Referring to FIG. 2, the AGI 22 may display the shiftable gear stage, and the dashboard 20 may display the current virtual gear stage next to the AGI 22. Further, the dashboard 20 may also display a virtual engine speed under the AGI 22. The dashboard 20 may be provided with a shift indicator 24, and may guide a shift time through the shift indicator 24.

The AGI 22 provides the driver with guidance about a shiftable virtual gear stage with reference to the current virtual gear stage by displaying information about the shiftable gear stage. The AGI 22 may display the shiftable gear stage in bold or gray.

The shiftable gear stage may be a gear stage that is downshifted or upshifted by at least one level from the current virtual gear stage. For example, in a case where the shiftable gear stage is “3” and the current virtual gear stage is “1”, the driver may perform shift to “2” or “3” by operating the gear shift device.

In other words, in the manual shift mode, the driver may perform shift to the shiftable gear stage guided through the AGI 22, or may perform shift to a gear stage between the shiftable gear stage and the current virtual gear stage. Here, the shiftable gear stage and the current virtual gear stage are drive ranges.

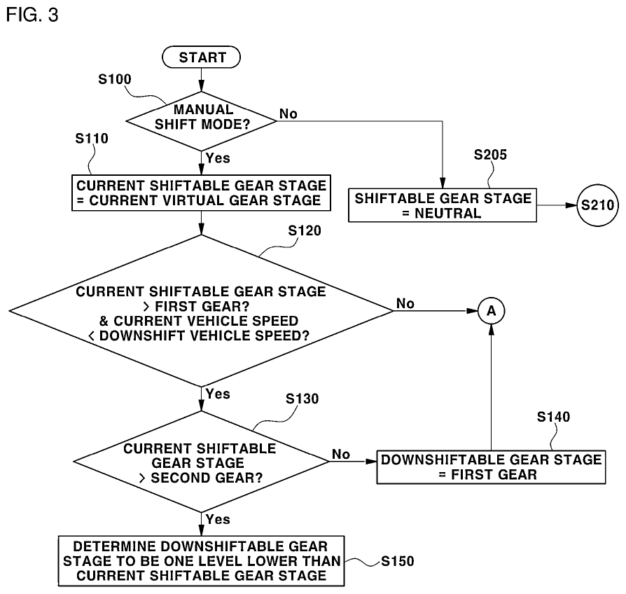

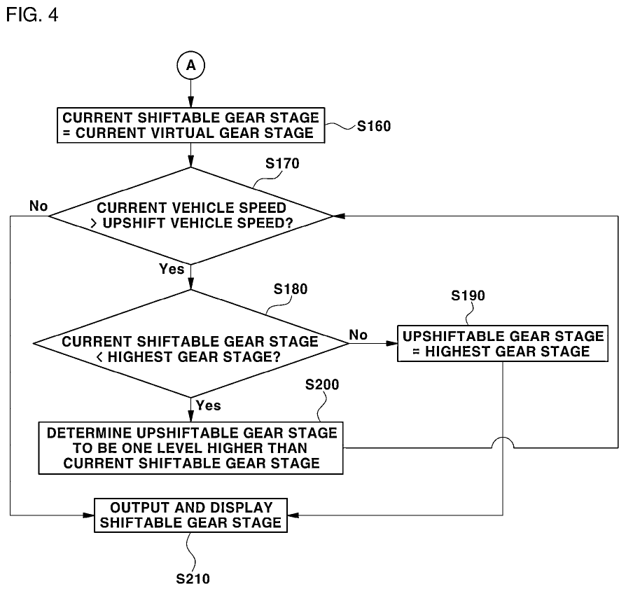

A method of guiding a shiftable gear stage of a vehicle according to an embodiment of the present disclosure is described with reference to FIGS. 3 and 4.

FIGS. 3 and 4 are flowcharts showing a method of guiding a shiftable gear stage of a vehicle according to an embodiment of the present disclosure. More specifically, FIG. 3 shows a method of guiding a downshiftable gear stage, and FIG. 4 shows a method of guiding an upshiftable gear stage.

Referring to FIG. 3, the control unit 10 first determines whether the driving mode of the virtual gear shift system is changed from the automatic shift mode to the manual shift mode (in an operation S100). In a case where it is determined that the virtual gear shift system has entered the manual shift mode, the control unit 10 determines a current virtual gear stage on the basis of a current vehicle speed, and outputs and displays the determined current virtual gear stage on the dashboard 20.

Then, the control unit 10 determines a shiftable gear stage (i.e., a current shiftable gear stage) displayed for the first time on the AGI 22 after the virtual gear shift system enters the manual shift mode as the same gear stage as the current virtual gear stage (in an operation S110), and displays the determined current shiftable gear stage on the dashboard 20 through the AGI 22. In other words, the control unit 10 outputs and displays the current shiftable gear stage as the same gear stage as the current virtual gear stage through the AGI 22 of the dashboard 20.

Then, the control unit 10 compares the current shiftable gear stage with a first gear stage (hereinafter referred to as “First gear”), and compares a current vehicle speed with a preset downshift vehicle speed (in an operation S120). The downshift vehicle speed is determined on the basis of a current opening degree of an accelerator pedal and the current virtual gear stage. The current opening degree of the accelerator pedal may be detected through an accelerator pedal position sensor provided in the electric vehicle.

The control unit 10 may be provided with a downshift vehicle speed map for determining the downshift vehicle speed, and may build and store the downshift vehicle speed map in advance. The downshift vehicle speed determined through the downshift vehicle speed map is a vehicle speed determined on the basis of a gear ratio determined according to a gear stage one level lower than the current virtual gear stage and the current opening degree of the accelerator pedal.

As a result of the comparison in in the operation S120, when the current shiftable gear stage is the First gear or lower, or when the current vehicle speed is less than the determined downshift vehicle speed, the control unit 10 performs operations S160-S200 (see FIG. 4).

Further, as a result of the comparison in the operation S120, when the current shiftable gear stage is higher than the First gear and the current vehicle speed during driving is less than the determined downshift vehicle speed, the control unit 10 performs an operation S130. In the operation S130, the control unit 10 compares the current shiftable gear stage with a second gear stage (hereinafter referred to as “Second gear”). If the current shiftable gear stage is higher than the Second gear, the control unit 10 determines a gear stage one level lower than the current shiftable gear stage as the downshiftable gear stage (in an operation S150), and executes the operation S120 again.

The control unit 10 repeatedly performs the operations S120-S150 until the determination in the operation S120 or S130 becomes negative, thereby decreasing the downshiftable gear stage one by one. Here, in a case where the determination in the operation S120 is negative, the downshiftable gear stage determined in the operation S150 is displayed through the AGI 22 of the dashboard 20 (in an operation S210 in FIG. 4), and in a case where the determination in the operation S130 is negative, the downshiftable gear stage determined in the operation S140 is displayed through the AGI 22 of the dashboard 20 (the operation S210 in FIG. 4).

In the operation S140, the control unit 10 determines the First gear as a downshiftable gear stage, and displays the determined downshiftable gear stage on the dashboard 20 through the AGI 22 (the operation S210 in FIG. 4).

In addition, in a case where an operation S160 (FIG. 4) is performed immediately without proceeding from the operations S120 to S130, the downshiftable gear stage is not determined, so that the downshiftable gear stage is not displayed on the dashboard 20.

When it is determined in the operation S100 that the virtual gear shift system has not entered the manual shift mode, the control unit 10 determines the shiftable gear stage as gear 0 (i.e., Neutral) (in an operation S205), and outputs and displays the determined shiftable gear stage on the dashboard 20 through the AGI 22 (in an operation S210 in FIG. 4).

Referring to FIGS. 3 and 4, the control unit 10 may perform the operation S160 subsequent to the operation S120 or S140. In the operation S160, the control unit 10 determines again the current shiftable gear stage as the same gear stage as the current virtual gear stage, and then, compares the current vehicle speed with a predetermined upshift vehicle speed (in an operation S170).

Here, the determining again the current shiftable gear stage as the same gear as the current virtual gear stage in the operation S160 is because, when the virtual gear shift system enters the manual shift mode, the upshiftable gear stage is also determined together with the downshiftable gear stage.

The upshift vehicle speed is determined on the basis of the current opening degree of the accelerator pedal and the current virtual gear stage. The control unit 10 may be provided with an upshift vehicle speed map for determining the upshift vehicle speed, and may build and store the upshift vehicle speed map in advance. The upshift vehicle speed determined through the upshift vehicle speed map is a vehicle speed determined on the basis of a gear ratio determined according to a gear stage one level higher than the current virtual gear and the current opening degree of the accelerator pedal.

As a result of the comparison in operation S170, in a case where the current vehicle speed during driving is the predetermined upshift vehicle speed or less, the operation S210 is performed. In a case where operations S180 and S200 are not performed after the operations S170 and the operation S210 is executed immediately, since the upshiftable gear stage is not determined, the upshiftable gear stage is not displayed on the dashboard 20.

As a result of the comparison in the operation S170, when the current vehicle speed is higher than the predetermined upshift vehicle speed, an operation S180 is executed. In operation S180, the current shiftable gear stage is compared with the highest gear stage. The highest gear stage is the highest gear stage among predetermined virtual drive ranges. For example, in a case where the virtual drive range is set to the First gear to Eighth gear (i.e., the eighth gear stage), the highest gear stage is the Eighth gear.

As a result of the comparison in operation S180, in a case where it is determined that the current shiftable gear stage is the highest gear stage or higher, the control unit 10 determines the highest gear stage as the upshiftable gear stage (in an operation S190), and displays the determined upshiftable gear stage on the dashboard 20 through the AGI (in the operation S210).

In a case where it is determined in the operation S180 that the current shiftable gear stage is lower than the highest gear stage, the control unit 10 determines a gear stage one level higher than the current shiftable gear stage as the upshiftable gear stage (in the operation S200) and performs the operation S170 again.

The control unit 10 repeatedly performs the operations S170-S200 until the determination in the operation S170 is negative or the determination in the operation S180 is negative, thereby sequentially increasing the upshiftable gear stage one by one. In a case where the determination in the operation S170 is negative, the upshiftable gear stage determined in the operation S200 is displayed through the AGI 22 of the dashboard 20 (the operation S210), and in a case where the determination in operation S180 is negative, the upshiftable gear stage determined in operation S190 is displayed through the AGI 22 of the dashboard 20 (operation S210).

Through the above-mentioned processes, either one of the upshiftable gear stage and the downshiftable gear stage, or both, may be displayed through the AGI 22 of the dashboard 20.

As described above, according to the present disclosure, it is possible to provide the method of outputting guidance for an upshiftable gear stage and a downshiftable gear stage in a manual shift mode of a virtual gear shift system on a display inside a vehicle, such as a dashboard 20 to make a driver clearly recognize the shiftable virtual gear stage in real time.

In addition, according to the present disclosure, it is possible to inform the driver of whether shifting is possible by guiding the current shiftable gear stage through the AGI 22.

Further, the present disclosure may also be applied to an internal combustion engine vehicle and a hybrid vehicle. However, when applied to the internal combustion engine vehicle and the hybrid vehicle, actual values are used instead of virtual values. For example, a gear stage value of a transmission mounted on an actual vehicle is used instead of a virtual gear stage.

The present disclosure has been described in detail with reference to embodiments thereof. However, it should be appreciated by those having ordinary skill in the art that changes may be made in these embodiments without departing from the principles and spirit of the present disclosure, the scope of which is defined in the appended claims and their equivalents.

### REFERENCE NUMERALS

10: Control unit
20: Dashboard
22: AGI

What is claimed is:

1. A method of guiding a shiftable gear stage of an electric vehicle, the method comprising:
determining, by a control unit, whether a virtual gear shift system of the electric vehicle enters a manual shift mode;
in response to determining that the virtual gear shift system enters the manual shift mode, determining, by the control unit, a shiftable gear stage based on a current vehicle speed; and
outputting, by the control unit, and displaying the determined shiftable gear stage on a display device inside the electric vehicle.

2. The method according to claim 1, wherein determining the shiftable gear stage comprises:
determining a downshiftable gear stage lower than a current virtual gear stage based on the current vehicle speed; and
determining an upshiftable gear stage higher than the current virtual gear stage based on the current vehicle speed.

3. The method according to claim 2, wherein determining the downshiftable gear stage comprises:
comparing a current shiftable gear stage with a first gear stage and comparing the current vehicle speed with a determined downshift vehicle speed;
when the current shiftable gear stage is higher than the first gear stage and the current vehicle speed is less than the downshift vehicle speed, comparing the current shiftable gear stage with a second gear stage; and
when the current shiftable gear stage is higher than the second gear stage, determining a gear stage one level lower than the current shiftable gear stage as the downshiftable gear stage.

4. The method according to claim 3, wherein determining the downshiftable gear stage is repeatedly performed until the current shiftable gear stage becomes the first gear stage or lower, or the current vehicle speed becomes the downshift vehicle speed or higher.

5. The method according to claim 3,
wherein comparing the current shiftable gear stage with the second gear stage comprises:
when the current shiftable gear stage is the second gear stage or lower, determining the downshiftable gear stage as the first gear stage.

6. The method according to claim 3, wherein the downshift vehicle speed is determined based on a current opening degree of an accelerator pedal and a gear ratio determined based on a gear stage one level lower than the current virtual gear stage.

7. The method according to claim 3, wherein when the virtual gear shift system enters the manual shift mode, the current shiftable gear stage is determined to be the same as the current virtual gear stage.

8. The method according to claim 3, wherein the current virtual gear stage is determined based on the current vehicle speed when the virtual gear shift system enters the manual shift mode.

9. The method according to claim 2, wherein determining the upshiftable gear stage comprises:
comparing the current vehicle speed with a predetermined upshift vehicle speed;
in response to determining that the current vehicle speed is higher than the upshift vehicle speed, comparing a current shiftable gear stage with a determined highest gear stage; and
in response to determining that the current shiftable gear stage is less than a highest gear stage, determining a gear stage one level higher than the current shiftable gear stage as the upshiftable gear stage.

10. The method according to claim 9, wherein determining the upshiftable gear stage is repeatedly performed until the current shiftable gear stage becomes the highest gear stage or higher, or the current vehicle speed becomes the upshift vehicle speed or lower.

11. The method according to claim 9, wherein comparing the current shiftable gear stage with the highest gear stage comprises:
determining, when the current shiftable gear stage is the highest gear stage or higher, the upshiftable gear stage as the highest gear stage.

12. The method according to claim 9, wherein the upshift vehicle speed is determined based on a current opening degree of an accelerator pedal and a gear ratio determined based on a gear stage one level higher than the current virtual gear stage.

13. The method according to claim 9, wherein when the virtual gear shift system enters the manual shift mode, the current shiftable gear stage is determined to be the same as the current virtual gear stage.

14. The method according to claim 9, wherein the current virtual gear stage is determined based on the current vehicle speed when the virtual gear shift system enters the manual shift mode.
